(19) United States
(12) Patent Application Publication
(10) Pub. No.: US 2008/0004968 A1
(43) Pub. Date: Jan. 3, 2008

(54) Method of obtaining desired phone number

(76) Inventor: John M. Nakao, Redondo Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/177,174

(22) Filed: Jul. 8, 2005

(51) Int. Cl. G06Q 30/00

(52) U.S. Cl. 705/26

(57) ABSTRACT

A third-party based system and method for identifying and matching buyers and sellers of telephone numbers. A buyer wanting to buy a phone number at a buying price is matched to a seller having that phone number. In one embodiment, a match can include a condition that the buying price be greater than or equal to a selling price of the seller. A database can store information about such buyers, potential buyers, sellers, and/or potential sellers, to make such matching process substantially more efficient. Once a match is made, the third-party can optionally facilitate the actual transfer of the phone number from the seller to the buyer.

### BACKGROUND

1. Field

The present teachings generally relate to buying and selling of telephone numbers, and in particular, to systems and methods for a third party that identifies and matches buyers and sellers of telephone numbers.

2. Description of the Related Art

When a new telephone service is established for a customer, that customer typically has little or no option to choose a phone number. Sometimes, the customer may be “lucky” and be allowed to select from a very limited set of numbers. Typically in such a situation, the customer picks one that is, for example, easy to memorize. Thus, the likelihood that a customer will be assigned a desirable phone number is very low.

Phone numbers may be desirable to different persons or businesses for different reasons. For example, numbers such as 555-5555 or 721-1000 are naturally desirable for simplicity. In another example, numbers can have special meanings or superstitious meanings (in which case some numbers are not desired). In yet another example, some businesses may want to have numbers having certain alphabet equivalents (e.g., “THE-BEST” has a numeric keypad equivalent of 843-2378).

A person or a business can contact the phone company to request a certain desirable phone number. If that number is available, the phone company may allow that person or business to obtain that number. However, with the proliferation of various phone-number based devices (e.g., cell phones), availability of phone numbers is becoming more limited. Thus, the likelihood that a desirable phone number is idly waiting to be obtained is, again, very low.

Thus, there is a need for an improved system and method for obtaining desirable phone numbers for users of telephones and other phone number-based devices.

### SUMMARY

The foregoing need can be addressed by a third-party based system and method for identifying and matching buyers and sellers of telephone numbers. A buyer wanting to buy a phone number at a buying price can be matched to a seller having that phone number. A match can include a condition that the buying price be greater than or equal to a selling price desired by the seller. A database can store information about such buyers, potential buyers, sellers, and/or potential sellers, to make the overall matching process more efficient. Once a match is made, the third-party can optionally facilitate the actual transfer of the phone number from the seller to the buyer.

One aspect of the present teachings relates to a method for providing a phone number matching service. The method includes obtaining a bid from a buyer to buy a first phone number at an at least a first price level. The method further includes seeking to obtain an offer from a seller. The offer includes willingness to sell a second number at a second price level. The method further includes matching the buyer to the seller if the first phone number is same as the second phone number, and the first price level is greater than or equal to the second price level.

In one embodiment, obtaining the bid includes obtaining a request from the buyer to acquire the first phone number at the first price level.

In one embodiment, obtaining the bid includes obtaining at least some control or authorization from the buyer to acquire the first phone number on behalf of the buyer.

In one embodiment, obtaining the offer includes obtaining a request from the seller to sell the second phone number at the second price level.

In one embodiment, obtaining the offer includes obtaining at least some control or right from the seller to sell the second number on behalf of the seller.

In one embodiment, obtaining the bid or offer includes providing an internet-based website that allows the buyer or seller to submit the bid or offer electronically. In one embodiment, the internet-based website includes a web-based auction functionality that facilitates matching of sellers with buyers.

In one embodiment, obtaining the bid or offer includes providing a relationship with an affiliate entity that facilitates the buyer or seller in submitting the bid or offer.

In one embodiment, the method further includes storing the bid and the offer in a database for possible later matching with other sellers or buyers if the matching is not successful.

In one embodiment, the method further includes negotiating with the buyer to determine if one of one or more similar alternate phone numbers would be acceptable for buying.

In one embodiment, the method further includes facilitating transfer of the first phone number from the seller to the buyer if the matching is successful.

In one embodiment, the method further includes determining, prior to matching the buyer to the seller, whether to proceed with the matching or to acquire the second phone number from the seller.

Another aspect of the present teachings relates to a system for matching a buyer with a seller of one or more phone numbers. The system includes a database that includes information about a request from at least one buyer, where the request includes at least a willingness to buy a first phone number. The database further includes information about at least one seller, where the information includes willingness to sell a second number. The system further includes a processor that is configured to match the buyer to the seller if the first phone number is same as or substantially same as the second phone number.

In one embodiment, the request includes a request from the buyer to acquire the first phone number at a first price.

In one embodiment, the information about the at least one buyer includes a willingness to provide at least some control or authorization from the buyer to acquire the first number on behalf of the buyer.

In one embodiment, the information about the at least one seller includes a desire to sell the second phone number at a second price.

In one embodiment, the information about the at least one seller includes a willingness to provide at least some control or right from the seller to sell the second number on behalf of the seller.

In one embodiment, the database is electronically linked to an internet-based website that allows the buyer or seller to submit the information electronically into the database. In one embodiment, the internet-based website includes a web-based auction functionality that facilitates matching of sellers with buyers.

In one embodiment, the system further includes an affiliate entity that interacts with the buyer or seller so as to facilitate the buyer or seller in submitting the information into the database.

In one embodiment, the system further includes a transfer module that facilitates transfer of the first phone number from the seller to the buyer.

In one embodiment, the processor is further configured to determine, prior to matching the buyer to the seller, whether to proceed with the matching or to acquire the second number from the seller.

Yet another aspect of the present teachings relates to a method for utilizing a database. The method includes obtaining information about one or more buyers, with each of the one or more buyers being interested in buying a phone number. The method further includes storing the information about one or more buyers in the database. The method further includes retrieving information about a first buyer from the stored information about the one or more buyers, with the first buyer being interested in buying a first phone number. The method further includes contacting a potential seller having the first phone number to determine whether the potential seller is willing to sell the first phone number to the first buyer.

In one embodiment, the method further includes matching the first buyer to the potential seller if the potential seller is willing to sell the first phone number. In one embodiment, matching further includes determining whether a bid price of the first buyer is greater than or equal to an offer price of the potential seller. In one embodiment, matching further includes designating the potential seller as a seller if the bid price is greater or equal to the offer price. In one embodiment, the method further includes facilitating transfer of the first phone number from the seller to the first buyer.

In one embodiment, obtaining information about the one or more buyers includes providing an internet-based website that allows electronic interactions with at least some of the one or more buyers. In one embodiment, the internet-based website includes a web-based auction functionality that facilitates matching of sellers with buyers.

In one embodiment, obtaining information about the one or more buyers includes providing a relationship with an affiliate entity that facilitates interactions with at least some of the one or more buyers.

Yet another aspect of the present teachings relates to a system that includes a database that is configured to include information about a plurality of buyers, with each of the plurality of buyers being interested in buying a phone number. The system further includes an interface that is configured to allow retrieval of information about a first buyer from the database, with the first buyer being interested in buying a first phone number. The system further includes a communication component that facilitates contact with a potential seller having the first phone number to determine whether the potential seller is willing to sell the first phone number.

In one embodiment, the system further includes a matching component that is configured to match the first buyer to the potential seller if the potential seller is willing to sell the first phone number. In one embodiment, the matching component is further configured to determine whether a bid price of the first buyer is greater than or equal to an offer price of the potential seller. In one embodiment, the matching component is further configured to designate the potential seller as a seller if the bid price is greater or equal to the offer price. In one embodiment, the system further includes a transfer component that facilitates transfer of the first phone number from the seller to the first buyer if the matching is successful.

In one embodiment, the system further includes an internet-based website that is electronically linked to the database, with the website being accessible to at least some of the plurality of buyers thereby allowing at least some of the plurality of buyers to submit information via the website. In one embodiment, the internet-based website includes a web-based auction functionality that facilitates matching of sellers with buyers.

In one embodiment, the system further includes an affiliate entity that interacts with at least some of the plurality of buyers so as to facilitate obtaining of information about at least some of the plurality of buyers.

Yet another aspect of the present teachings relates to a method for providing phone number matching service. The method includes receiving a request from a buyer desiring to purchase a phone number. The method further includes determining from the buyer a purchase price range. The method further includes identifying the owner of the phone number. The method further includes determining whether the owner is willing to sell the phone number. The method further includes facilitating transfer of the phone number if the owner is willing to sell the phone number.

In one embodiment, determining the purchase price range includes determining a bid price.

In one embodiment, determining the purchase price range includes determining a bid and a maximum price that the buyer is willing to pay for the phone number.

In one embodiment, identifying the owner of the phone number includes calling the phone number.

In one embodiment, facilitating transfer of the phone number includes referring the buyer and the owner to a third party entity that facilitates payment of the purchase price and transfer of the ownership of the phone number.

In one embodiment, facilitating transfer of the phone number includes providing an escrow service that facilitates payment of the purchase price and transfer of the ownership of the phone number.

In one embodiment, facilitating transfer of the phone number includes providing instructions to the buyer and the owner on payment of the purchase price and transfer of the ownership of the phone number.

In one embodiment, the method further includes storing information about the buyer if the owner of the phone number is not willing to sell the phone number. In one embodiment, the stored information is used for possible matches at a later time.

Yet another aspect of the present teachings relates to a method for providing a phone number matching service. The method includes obtaining a request from a buyer to buy a first phone number. The method further includes seeking to obtain an offer from a seller, with the offer comprising willingness to sell a second number. The method further includes facilitating a transfer of the first phone number to the buyer from the seller.

In one embodiment, obtaining the request includes obtaining a request from the buyer to acquire the first phone number at a first price level.

In one embodiment, obtaining the offer includes obtaining a request from the seller to sell the second phone number at a second price level.

In one embodiment, obtaining the offer includes obtaining at least some control or right from the seller to sell the second number on behalf of the seller.

In one embodiment, obtaining the request or offer includes providing an internet-based website that allows the buyer or seller to submit the bid or offer electronically.

In one embodiment, the internet-based website includes a web-based auction functionality that facilitates matching of sellers with buyers.

In one embodiment, obtaining the request or offer includes providing a relationship with an affiliate entity that facilitates the buyer or seller in submitting the bid or offer.

In one embodiment, the method further includes storing the request and the offer in a database for possible later matching with other sellers or buyers if the matching is not successful.

In one embodiment, the method further includes negotiating with the buyer to determine if one of one or more similar alternate phone numbers would be acceptable for buying.

### BRIEF DESCRIPTION OF THE DRAWINGS

FIG. 1A shows a block diagram of one embodiment of a third party-facilitated matching system that identifies and matches buyers with sellers of phone numbers;

FIG. 1B shows one embodiment of a process that can be performed by the system of FIG. 1A;

FIG. 2A shows a block diagram of another embodiment of a matching system that is a variation of the system of FIG. 1A;

FIG. 2B shows one embodiment of a process that can be performed by the system of FIG. 2A;

FIG. 3 shows one embodiment of a process for matching a buyer to a seller;

FIGS. 4A and 4B show different example embodiments of a third-party matching service;

FIGS. 5A-5D show by example complexities in buyer-seller relationships that can arise without the services of a matching service;

FIGS. 6A-6D show by example similar buyer-seller settings with the services of a matching service, showing how the complexities can be reduced substantially;

FIG. 7 shows a generalized relationship where a matching service matches a plurality of sellers with a plurality of buyers;

FIG. 8A shows one embodiment of an example process that attempts to match a buyer to a seller;

FIG. 8B shows one embodiment of an example process that attempts to match a seller to a buyer;

FIG. 8C shows one embodiment of an example process that transfers a phone number between a seller and a buyer based on the matching service being given at least some right or control to do so;

FIGS. 9A-9C show various example embodiments of a matching service configured to promote consumer awareness of its service;

FIGS. 10A-10D show various example embodiments of a matching system configured to promote interactions with consumers;

FIGS. 11A and 11B show example embodiments of a matching system where a matching service has at least some right or control to do transfer phone numbers from sellers to buyers;

FIG. 12 shows one embodiment of a process for transferring a phone number from a seller to a buyer that has been matched;

FIG. 13A shows one embodiment of a phone number transfer system that facilitates transfer of a phone number between the seller and the buyer;

FIG. 13B shows one embodiment of a process that can be performed by the matching service of the system of FIG. 13A;

FIG. 14A shows one embodiment of a phone number transfer system that is a variation of the system of FIG. 13A;

FIG. 14B shows one embodiment of a process that can be performed by the matching service of the system of FIG. 14A;

FIG. 15A shows one embodiment of a phone number transfer system that is another variation of the system of FIG. 13A;

FIG. 15B shows one embodiment of a process that can be performed by the matching service of the system of FIG. 15A;

FIG. 16 shows one embodiment of an example business model that can be implemented to operate the matching system;

FIG. 17 shows one embodiment of the example business model of FIG. 16;

FIG. 18 shows another embodiment of the example business model of FIG. 16; and

FIGS. 19A and 19B show example embodiments of some of the components of the example business model of FIG. 17.

These and other aspects, advantages, and novel features of the present teachings will become apparent upon reading the following detailed description and upon reference to the accompanying drawings. In the drawings, similar elements have similar reference numerals.

### DETAILED DESCRIPTION OF SOME EMBODIMENTS

As described herein, the present teachings generally relate to systems and methods for providing a third party service that identifies and matches seller(s) or potential seller(s) with buyer(s) or potential buyer(s) of telephone numbers. For the purpose of description, a “seller” means a person or an entity that is interested or potentially interested in selling one or more of its telephone numbers. Similarly, a “buyer” means a person or an entity that is interested or potentially interested in buying one or more telephone numbers from one or more sellers. Also for the purpose of description, a telephone number is sometimes referred to as “phone number” or simply as “number.”

Typically, a buyer might want to buy a telephone number that is desirable to him for some reason. For example, the desired number may be easy to remember or have some special meaning for the buyer. If the desired number is XXX-YYY-ZZZZ, the buyer can simply call that number and attempt to buy the rights to the number. If the owner is willing to part with the number at some price, the owner can sell the number to the buyer. As described herein, various embodiments of the present teachings relate to a third-party service that identifies and matches a plurality of such sellers with such buyers. It will be shown that such identification and matching service can provide a substantial advantage when matching a relatively large number of phone numbers, or where the buyer and/or seller desires to have a third party intermediary to handle the negotiation and/or transaction. For the purpose of description, the identification and matching of a phone number is also referred to as “porting.”

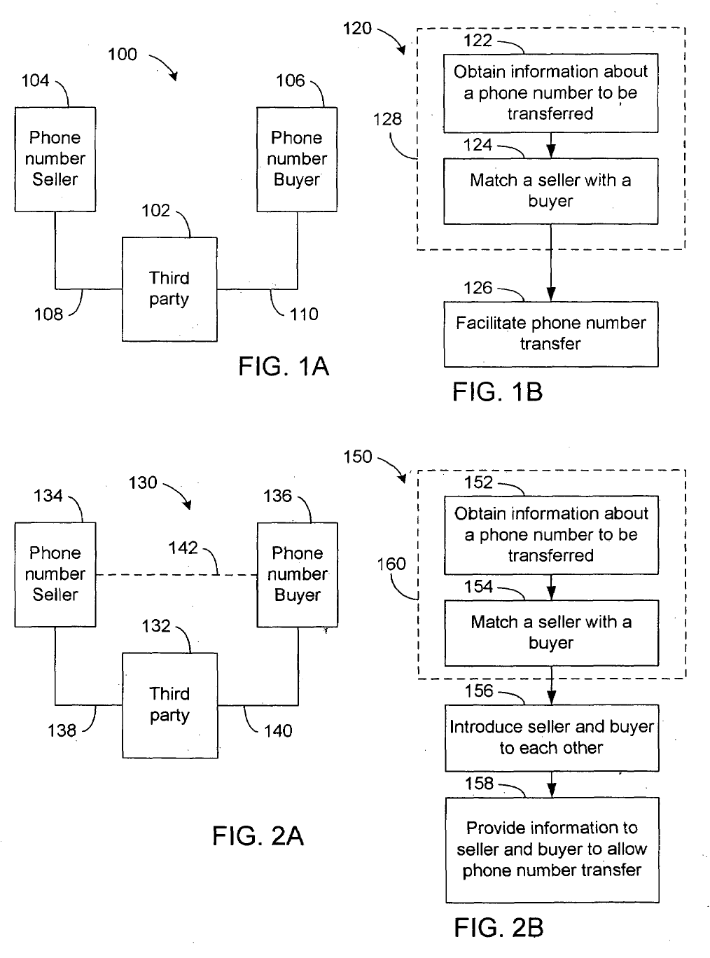

FIG. 1A shows a block diagram of one embodiment of a phone number matching system 100 that includes a third party service 102 that performs a communication with a phone number seller 104 (as indicated by line 108) and a phone number owner/seller 106 (as indicated by line 110). As shown in FIG. 1B, the third party service 102 can perform a process 120 that includes an identification and matching function 128. In one embodiment, the identification and matching function 128 includes a step 122 where the process 120 obtains information about a phone number to be transferred. In one embodiment, such information can be requested or provided by a buyer or a seller. In a step 124, the process 120 matches the seller to the buyer based on the obtained information.

As further shown in FIG. 1B, the process 120 can optionally include a phone number transfer step 126 where the process 120 facilitates transfer of the phone number between the seller and the buyer. It will be understood that in one embodiment, the process 120 does not include the phone number transfer step 126.

FIGS. 2A and 2B show one embodiment of a phone number matching system 130 and one embodiment of a matching process 150 that are variations to the system 100 and the process 120 described above in reference to FIGS. 1A and 1B. The phone number matching system 130 includes a third party service 132 that performs a communication with a phone number seller 134 (as indicated by a line 138) and a phone number buyer 136 (as indicated by a line 140). In one embodiment as shown in FIG. 2A, the third party service 132 may provide information to the seller 134 and/or the buyer 136 to allow them to communicate (as indicated by line 142) to facilitate the progress of a transaction. For example, if the seller 134 and the buyer 136 have already been identified and matched at an agreed-upon price, then the communication 142 between the seller 134 and the buyer 136 may be for the purpose of facilitating the transfer of funds and/or the phone number. In another example, if the seller 134 and the buyer 136 have already been identified but not matched with respect to the price, then the communication 142 may be for the purpose of negotiation.

As shown in FIG. 2B, the third party service 132 can perform a process 150 that includes an identification and matching function 160. In one embodiment, the identification and matching function 160 includes a step 152 where the process 150 obtains information about a phone number to be transferred. In one embodiment, such information can be requested/provided by a buyer or a seller. In a step 154, the process 150 matches the seller to the buyer based on the obtained information.

As further shown in FIG. 2B, the process 150 can optionally include a step 156 of introducing the seller and the buyer. In an additional step 158, the process 150 can provide information to the seller and the buyer to allow transfer of funds and/or the phone number. It will be understood that in one embodiment, the process 150 does not include the introduction and transfer steps 156 and 158.

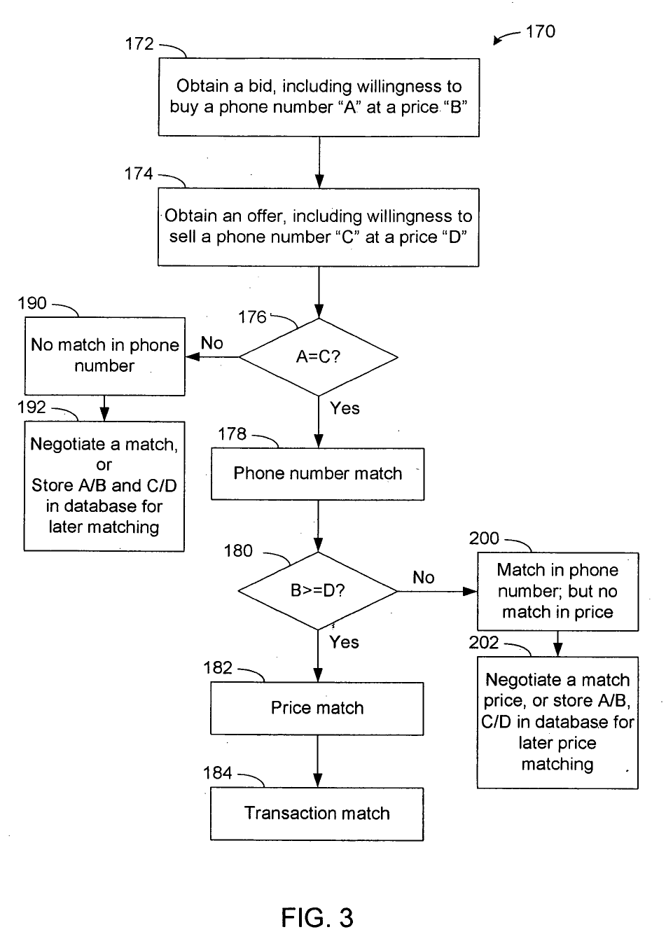

FIG. 3 shows one embodiment of a process 170 that identifies and matches a buyer and a seller for a given phone number at a given price. The process 170 can be performed, for example, as part of the identification and matching function (128 in FIG. 1B, and 160 in FIG. 2B).

The process 170 includes a bid step 172 where a bid, including a willingness to buy a phone number “A” at a price “B,” is obtained. In an offer step 174, the process 170 obtains an offer, including willingness to sell a phone number “C” at a price “D.”

In one embodiment, information about the seller's phone number “C” and the selling price “D”, or the buyer's desired phone number “A” and the bid price “B” can exist in a database. Thus, a request by the buyer to buy a phone number, or a willingness by the seller to sell a phone number can be compared to such a database.

In another embodiment where a buyer requests to buy the phone number “A” at the price “B,” and the phone number “A” is not on a “sell” list (such as in the aforementioned database), the phone number “A” can be contacted by the process 170, to see if the owner of the phone number “A” might be willing to sell that number at the price “B.” Whether or not the owner of the phone number “A” is willing to sell the number at the price “B,” information obtained in such a manner can be used by the process 170 to determine whether a match in the phone number and the price can be made. The process 170 can also be configured to allow at least some form of negotiation involving the seller and/or the buyer if the bid price is less than what the potential seller is willing sell for.

The process 170, in a decision step 176, determines whether the buyer-desired phone number “A” is same as the seller's phone number “C.” If the answer is “yes,” the process 170 in a number match step 178 determines that a phone number match is made. If the answer is “no,” the process 170 in a no number match step 190 indicates that a phone number match is not made. In one embodiment, in a further number match attempt step 192, a phone number match can be negotiated by changing the preferences of the buyer and/or the seller. In one embodiment, the process 170 in the further number match attempt step 192 stores information about A/B and C/D in a database for later matching if such negotiation is not successful.

If the phone number match has been determined in the decision step 176 and the number match step 178, the process 170 then determines in a decision step 180 whether bid price “B” is greater than or equal to the asking price “D.” If the answer is “yes,” the process 170 in a price match step 182 determines that a price match is made. In one embodiment, a price match is made with the bid price “B” being substantially equal to the asking price “D.” If the answer is “no,” the process 170 in a no price match step 200 indicates that while the phone number match has been made, a price match is not made. In one embodiment, the process 170 in a further price match attempt step 202 can attempt to match the price, or store information about A, B, C, and D in a database for later price matching, or phone number matching (and corresponding price matching) with other phone numbers.

In one embodiment as shown in FIG. 3, once the phone number match 178 and price match 182 have been made, the process 170 in a step 184 determines that a transaction match is made.

In one embodiment, the foregoing identifying and selling of phone number buyer and/or seller can be facilitated by a processor and a database associated with the third party service.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

It will also be appreciated that a database can be integrated, distributed, or any combination thereof. In one embodiment of a database that is distributed, access can be granted at different levels. For example, some may have a limited access (e.g., querying for a “yes” or “no” answer), while others can have greater access.

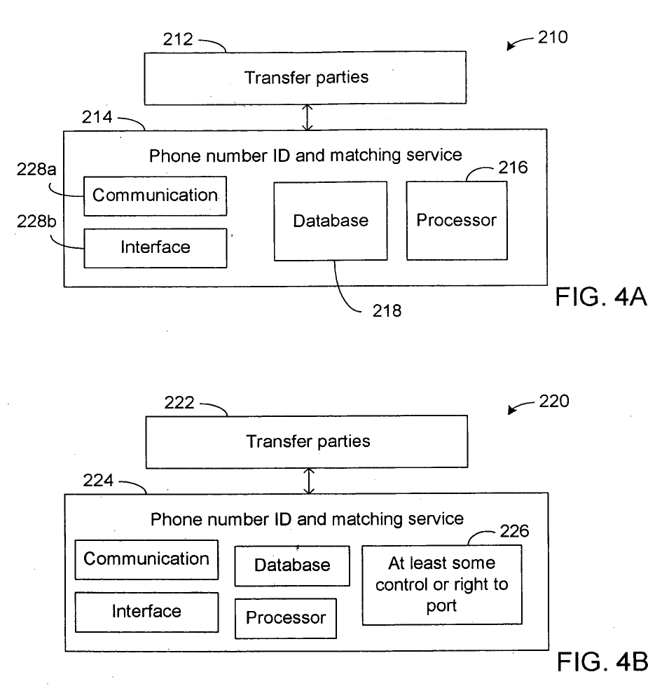

Thus in one embodiment as shown in FIG. 4A, a phone number matching system 210 can include a third party phone number identification (“ID”) and matching service 214 that interacts with buyers and sellers (collectively depicted as transfer parties 212). The identification and matching of the buyers and sellers can be, in one embodiment facilitated by a processor 216 and a database 218.

In one embodiment as shown in FIG. 4A, the matching service 214 can also include a communication component 228a that facilitates interaction between the matching service 214 and the parties 212. In one embodiment, the communication component 228a includes, by way of example, marketing and sales facilitated by electronic components such as telephones, emails, and other internet-based applications.

In one embodiment as further shown in FIG. 4A, the matching service 214 can also include an interface component 228b. Interface component 228b can allow interfacing with the database 218 by a person or a component associated with the matching service. Thus, such interface can allow storing of information to the database 218, and retrieval of information from the database 218, to facilitate the matching process as described herein.

In one embodiment, the ID and matching service 212 simply identifies and matches sellers with buyers, and does not obtain controlling interest in the phone numbers being transferred. In one embodiment, the service may obtain such an interest with at least some of the phone numbers. FIG. 4B shows one embodiment of a matching system 220 having a third party service 224 that interacts with transfer parties 222. In addition to the processor and the database that facilitate the ID and matching process, the service 224 can further includes a component 226 associated with at least some control or right to port one or more phone numbers. Such control or right can include, for example, obtaining a contractual agreement with a seller who authorizes the matching service 224 to find and sell the seller's phone number. In such a situation, the seller may be only interested in an agreed-upon price with the service 224. Given such an example control of the phone number, the service 224 can typically realize an arbitrage or arbitrage-like profit by finding a buyer who is willing to pay a buy price that is greater than the seller's price.

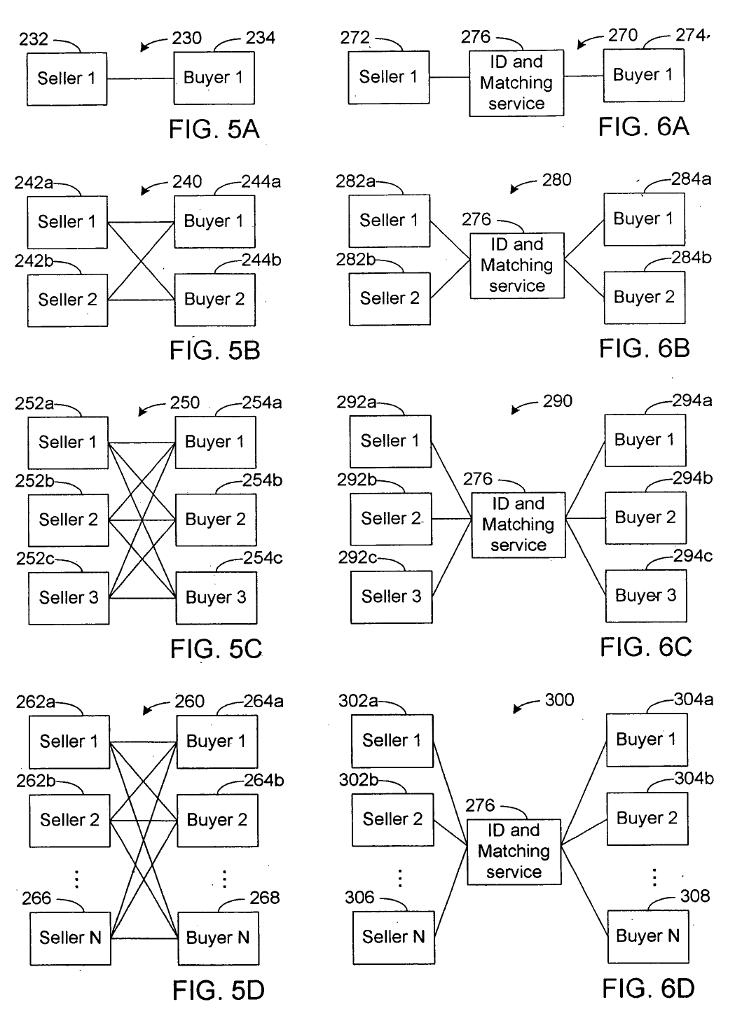

FIGS. 5 and 6 show by examples how an ID and matching service (also referred herein as simply matching service) 276 can provide improved efficiency in matching of sellers with buyers. FIGS. 5A to 5D show by example, one-seller/one-buyer, two-seller/two-buyer, three-seller/three-buyer, and N-seller/N-buyer situations, where phone number matching attempts are made without the matching service. FIGS. 6A to 6D show by similar example, one-seller/one-buyer, two-seller/two-buyer, three-seller/three-buyer, and N-seller/N-buyer situations, where the matching service 276 facilitates phone number matching attempts.

As shown in FIG. 5A, an example one-seller/one-buyer matching situation 230 includes one interaction between a seller 232 and a buyer 234. In comparison, as shown in FIG. 6A, an example one-seller/one-buyer matching situation 270 facilitated by the matching service 276 includes two interactions—one between the service 276 and the seller 272, and one between the service 276 and the buyer 274.

As shown in FIG. 5B, an example two-seller/two-buyer matching situation 240 includes four interactions overall between sellers 242a, 242b and buyers 244a, 244b. The situation 240 can arise, for example, when the first and second sellers 242a, 242b have first and second phone numbers, either of which are desirable to the first and second buyers 244a, 244b. Thus, the first buyer 244a may contact both first and second sellers 242a, 242b to obtain a desirable number at a desirable price. Similarly, the second buyer 244b may contact both first and second sellers 242a, 242b to obtain a desirable number at a desirable price.

In comparison, as shown in FIG. 6B, an example two-seller/two-buyer matching situation 280 facilitated by the matching service 276 includes four interactions overall—one interaction between the service 276 and each of two sellers 282a, 282b, and each of two buyers 284a, 284b. The situation 280 can arise in a similar situation as the example described above in reference to FIG. 5B.

As shown in FIG. 5C, an example three-seller/three-buyer matching situation 250 includes nine interactions overall between sellers 252a, 252b, 252c and buyers 254a, 254b, 254c. The situation 250 can arise, for example, when the three sellers 252a, 252b, 252c each have phone numbers, any of which are desirable to the three buyers 254a, 254b, 254c. Thus, the first buyer 254a may contact all three sellers 252a, 252b, 252c to obtain a desirable number at a desirable price. Similarly, the second and third buyers may each make three contacts with the three sellers.

In comparison, as shown in FIG. 6C, an example three-seller/three-buyer matching situation 290 facilitated by the matching service 276 includes six interactions overall—one interaction between the service 276 and each of three sellers 292a, 292b, 292c, and each of three buyers 294a, 294b, 294c. The situation 290 can arise in a similar situation as the example described above in reference to FIG. 5C.

FIG. 5D shows a generalized N-seller/N-buyer matching situation 260 without the aid of the matching service. One can see that the matching situation 260 includes N×N interactions overall when there are N sellers 262 having phone numbers that are desirable to N buyers 264.

In comparison, as shown in FIG. 6D, a generalized N-seller/N-buyer matching situation 300 with the aid of the matching service 276 includes N+N interactions overall when there are N sellers 302 having phone numbers that are desirable to N buyers 304. Thus, one can see that the overall number of interactions can be characterized as N×N (multiplicative) when not aided by the matching service, and as N+N (additive) when aided by the matching service. When the number N is relatively small, such as one or two, the benefit of the matching service may not be apparent. In fact, in the one-seller/one-buyer case, it may be more efficient overall for the single buyer to contact the single seller directly. But as shown in FIGS. 5 and 6, the difference between N+N and N×N becomes quite apparent and dramatic when the value of N becomes larger. For example, when N=10, N+N=20, and N×N=100. In another example, when N=100, N+N=200, and N×N=10,000.

As shown in FIGS. 6A to 6D, each of the sellers and buyers are depicted as having a substantially single interaction with the matching service. It will be understood that the single interaction may involve one or more phone calls or other forms of communication. Nevertheless, the interaction by a given seller or a buyer is with the matching service for the purpose of identification and matching. It will also be understood that a given single interaction in the situations of FIGS. 5A to 5D also may involve one or more phone calls or other forms of communication. Without the aid of the matching service, however, a given buyer (or seller) may need to make N such interactions.

Such example N interactions can be by substantially direct contacts, by some accessible medium (such as “want-to-buy” website or “want-to-sell” website such as an electronic auction website), or some combination thereof. Whatever the case may be, the seller or buyer may need to address those N interactions (or at least a substantial portion of the N interactions)—for example, to answer questions and/or to negotiate.

Thus, one can see that from the perspective of a given seller or a given buyer, the presence of the matching service 276 greatly simplifies the process of selling or buying a phone number, generally regardless of the market size. In one embodiment, the seller makes one interaction with the matching service, and the buyer makes one interaction with the matching service, for the purpose of identifying and matching a seller-buyer combination for a given phone number at a given price. In one embodiment, such an interaction with the matching service can also involve an interested party's (seller or buyer) preference to have the matching service perform negotiations, if any, with the other party.

The example seller/buyer situations depicted in FIGS. 5 and 6 used the same number (N) of sellers as the buyers to demonstrate in a simple manner the additive (number of sellers plus number of buyers) nature of the overall number of interactions when the matching service is involved, in comparison to the multiplicative (number of sellers times number of buyers) nature when the matching service is not involved. Such a difference in the characteristics of complexity can be extended to a more realistic situation where the number of sellers is different than the number of buyers. In fact, when large numbers of sellers and buyers are involved, it is unlikely that the number of sellers will be the same as the number of buyers at a given time.

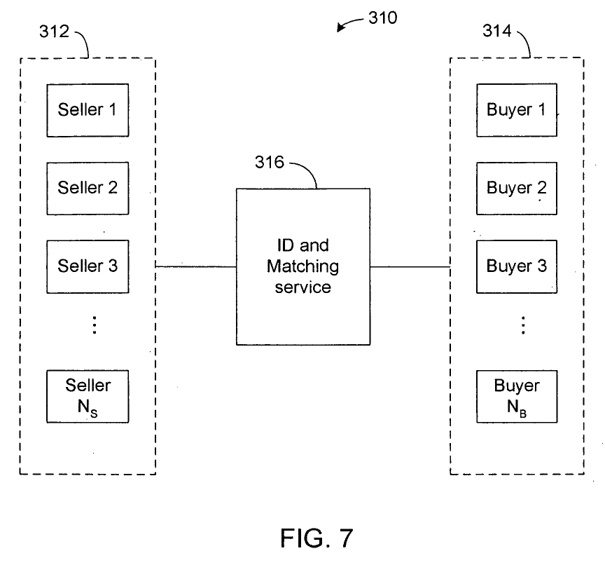

FIG. 7 shows one embodiment of a phone number matching system 310 where a group of N_{S} sellers 312 and a group of N_{B} buyers 314 are serviced by a matching service 316. In general, N_{S} and N_{B} may or may not be the same. As described above in reference to FIGS. 5 and 6, the number of overall interactions involved in such a system can be approximated as N_{S}+N_{B}. In one embodiment also as described, as far as each of the sellers and buyers is concerned, one interaction with the matching service 316 can suffice for the purpose of matching, regardless of the number of buyers or sellers.

The number of sellers, N_{S}, and the number of buyers, N_{B}, can depend on how the matching service is configured to operate. As described below in greater detail the matching service can be configured to attract sellers (thereby increasing N_{S}), to attract buyers (thereby increasing N_{B}), or to attract both sellers and buyers (thereby increasing N_{S} and N_{B}). In one embodiment, the matching service attempts to increase the numbers of sellers and buyers, and identify and match substantially all or substantial portion of the sellers with substantially all or substantial portion of the buyers.

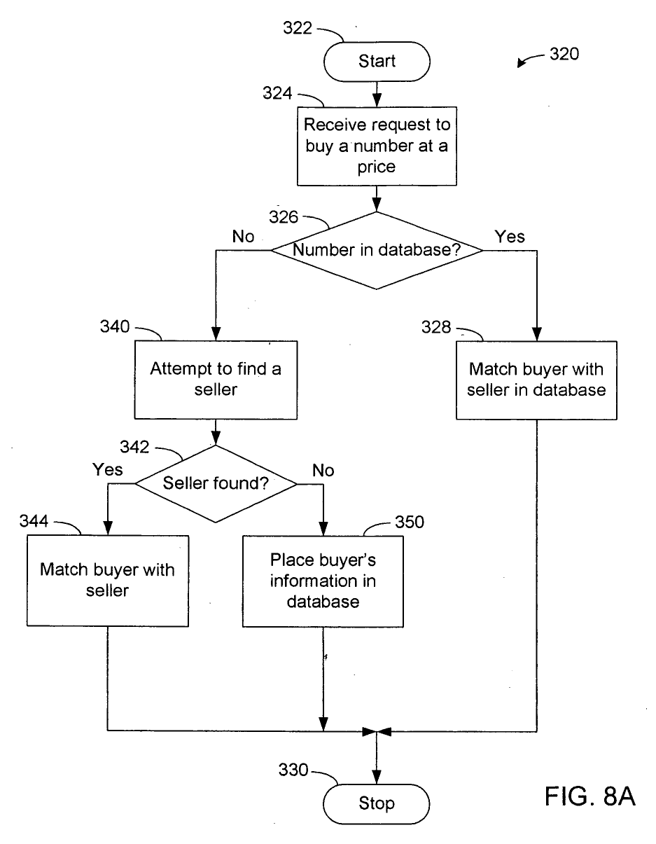

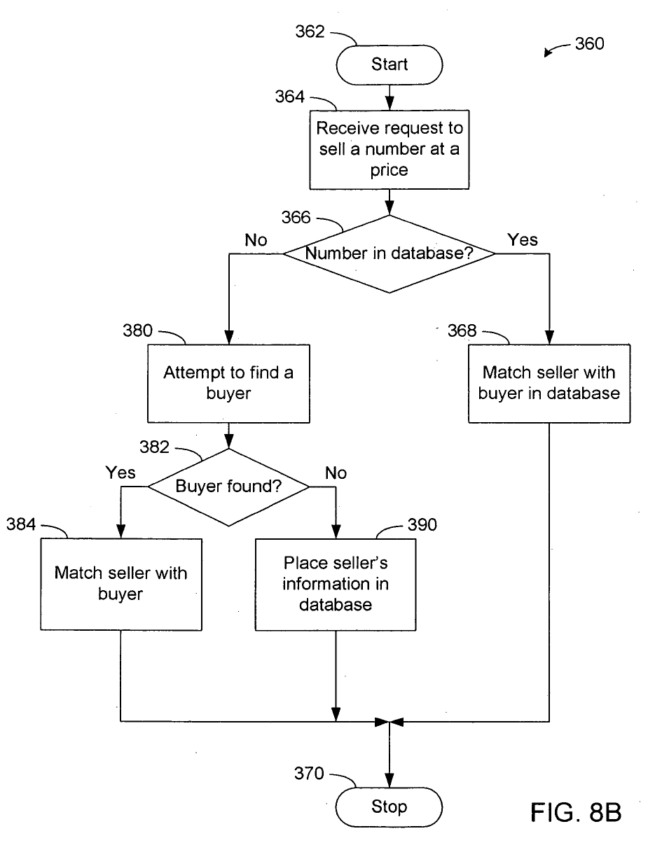

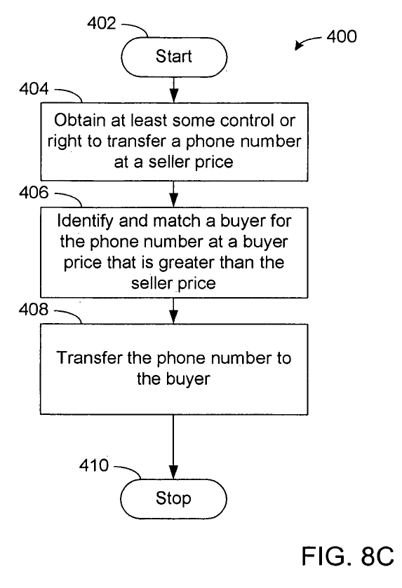

FIGS. 8A and 8B show example processes 320 and 360 that performs such matching attempts driven by buyers and sellers, respectively. As shown in FIG. 8A, the process 320 begins at a start 322 for a given buyer. In a step 324, the process 320 receives a request from a buyer to buy a phone number at a given price. In one embodiment, the request from the buyer is a new request. The process 320 then determines in a decision step 326 whether the phone number is already in a database awaiting to be sold. If the answer is “yes,” then the process 320 in a step 328 matches the buyer with the seller in the database. As described above, the matching can include a number matching (which is already done at this stage for the example process 320) as well as price matching. For the purpose of description of the process 320, it will be assumed that price matching also occurs in the step 328. Once the match is made, the process 320 ends at a stop 330.

If the answer in the decision step 326 is “no,” the process 320 in a step 340 attempts to find a seller. In one embodiment, such a seller is a new seller who is currently not in the database. Examples of how the matching service can find sellers are described below in greater detail. The process 320 then determines in a decision step 342 whether a seller has been found. If the answer is “yes,” the process 320 in a step 344 matches the buyer with the found seller. The process 320 then ends at the stop 330. If the answer is “no,” the process 320 stores information about the buyer in a database for one or more purposes, including for a later attempt to find a seller. The process 320 then ends at the stop 330.

In one embodiment, the process 320 of FIG. 8A may be modified so that if the buyer's desired number does not have a direct match in the database, one or more similar numbers (that are in the database) can be presented to the buyer. In such a situation, the buyer may be willing to buy one or more of the similar numbers at a price that is similar to or different than the original price for the original desired number. For example, if the buyer simply wants a convenient number (e.g., 273-3000), the buyer might not care if the number ends in “3000” or “4000.” Thus, if the example number “273-3000” is not in the “available” database, but the example number “273-4000” is, the available number can be presented to the buyer for purchase at the same price as the original price.

An example of a phone number matching process that uses the process 320 of FIG. 8A, or some variation thereof, can be as follows. Suppose that Buyer1 wants a particular phone number for a vanity purpose. His ideal vanity translation would be “ONE-DUDE” in his area code. Using one of the many vanity phone number translators available on the internet, or by using the keypad on a phone, Buyer1 determines that the phone number that corresponds to “ONE-DUDE” is 663-3833. Realizing that the prefix “663” may not be available or practical for him, he is willing to settle for “DUDE,” so that when he gives out his phone number, he can simply say the prefix followed by “DUDE.” Buyer1 is willing to pay up to $200 to obtain the number 663-3833, and up to $100 to obtain a number having the last four digits 3833. For now, he does not reveal the fact that he is willing to settle for one of the many numbers that have the “DUDE” (3833) ending.

With the foregoing example criteria in mind, Buyer1 contacts the phone number matching service that includes a website. Buyer1 fills out his contact information including his ZIP code and/or area code, the desired number 663-3833, and the price he is willing to pay. Buyer1 also chooses “Maybe” option on a question that asks whether an alternate number would be acceptable if the desired number 663-3833 is not available.

Based on the information provided by Buyer1, the phone number matching service automatically sends a confirmation email to Buyer1 thanking him and providing him with an order number. The phone number matching service may determine the area code by either using Buyer1's input, or by using Buyer1's ZIP code, and checks its database to see if the number 663-3833 is available for that area code. For the purpose of this example, suppose that the number 663-3833 is not available for that area code in the database. The phone number matching service then instructs a representative (either in-house, an affiliate, or some automated calling system) to contact the phone number 663-3833 to see if its owner might be willing to sell the number. For the purpose of this example, suppose that an in-house caller calls the number 663-3833.

The caller's call to the number 663-3833 is answered, and the owner of that number, while slightly irritated by the call, realizes that he can make some money by selling his number that really does not mean much to him. The owner of the number 663-3833 tells the caller that he is willing to sell the phone number at $300. The caller thanks the owner and informs him that he will check to see if that price is acceptable to the buyer.

The caller indicates in a phone number matching service computer system that a phone number match is made, and also enters the sell price of $300. The sell price of $300 is compared with Buyer1's bid price of $200. Suppose that the example phone number matching service has a policy that if the sell price is within five percent of the bid price, the bid and sell prices are considered to be “matched,” even if the two figures are not exactly the same. If the price is matched, the matching seller/buyer information is passed along to a transfer component for subsequent processing. If the matched prices are not exactly the same, the phone number matching service can have an example policy that the difference be split between the seller and the buyer, or that one party pick up the difference. If the price is not matched, the phone number matching service has an example policy of contacting the buyer to see if the sell price might be acceptable.

In this example, the difference between $200 and $300 is well outside of the example 5% range. Thus, the phone number matching service sends an email to Buyer1 informing him that the number 663-3833 is available, but the sell price is $300. The email can ask if Buyer1 might be willing to pay $300, or consider increasing his bid price. Buyer1 is not willing to pay $300, but he is willing to increase his bid to $225. Upon receipt of such information, the phone number matching service sends an email to the owner of 663-3833, informing him that the increased bid is at $225. The email can ask if the owner might be willing to sell for $225, or consider lowering the sell price. The owner is not willing to sell at $225, but he is willing to lower the sell price to $250. Another round of negotiations with Buyer1 and the owner of 663-3833 does not result in the bid and sell prices. The phone number matching service has an example policy that if two rounds of negotiations is the limit. Thus in this example, the price matching attempt fails.

The phone number matching service informs the owner of 663-3833 that the price could not be matched, and thus the transaction will not proceed. The owner is also informed that the phone number 663-3833 will remain in the database for 90 days (an example period). After that, the owner has an option of keeping his number in the database for a non-recurring or recurring fee until the number is sold.

In one example fee structure for keeping a number “listed” in the database, a seller can have an option to have his/her number listed until sold for a fixed fee (e.g., $9.95), or for a fixed term that can be renewed (e.g., $4.95 for five years). For a buyer, an example non-refundable registration fee (e.g., $49.95) can be charged when the buyer registers. For such a fee, the buyer can be entitled to efforts by the phone number matching service to find a match for the buyer.

The phone number matching service also informs Buyer1 that the price could not be matched, and thus this particular transaction for 663-3833 will not proceed. Because Buyer1 had originally indicated that he might be willing to buy an alternate number, Buyer1 is asked what the alternate number might be. Buyer1 indicates that he is now willing to buy any number in his area code that ends in “3833.” With this new request, several calls are made to numbers that end in 3833 and having prefixes that generally correspond to Buyer1's ZIP code. From these calls, an owner of the number 259-3833 is found to be willing to sell his number for $100, and thus both phone number and price matches are made. Thus, the owner of the number 259-3833 is now Seller1. An example of how a transfer of the number 259-3833 can be made between Seller1 and Buyer1 is described below where various embodiments of transfers are discussed.

Another example of a matching process can be as follows. Suppose that Buyer2 owns a small business with a need for five phone numbers. Buyer2 would prefer to have all five numbers only differ in the last digit. Preferably, she would like to have the last digits be as follows: “1” for herself, “2” for the fax, and “3” to “5” for her employees. Buyer2 contacts the phone number matching service, and the block of five phone numbers are indicated. The phone number matching service can check the availability of phone numbers individually, check the availability of blocks of phone numbers, or some combination thereof. For individual numbers, the phone number matching service can perform similar matching attempts as with Buyer1. For block of numbers, a database can be checked to see if a block that meets Buyer2's preference exists. Calls can also be made to determine the existence of such a block. Assuming that such a block exists, additional negotiation may involve determination to see if the owner of the block is willing to sell only that block of five numbers. If such willingness is found, the block of five numbers can be transferred in an example similar to that described below (with respect to Buyer1) where various embodiments of transfers are discussed.

As shown in FIG. 8B, a similar process 360 begins at a start 362 for a given seller. In a step 364, the process 360 receives a request from a seller to sell a phone number at a given price. In one embodiment, the request from the seller is a new request. The process 360 then determines in a decision step 366 whether the phone number is already in a database awaiting to be purchased. If the answer is “yes,” then the process 360 in a step 368 matches the seller with the buyer in the database. As described above, the matching can include a number matching (which is already done at this stage for the example process 360) as well as price matching. For the purpose of description of the process 360, it will be assumed that price matching also occurs in the step 368. Once the match is made, the process 360 ends at a stop 370.

If the answer in the decision step 366 is “no,” the process 360 in a step 380 attempts to find a buyer. In one embodiment, such a buyer is a new buyer who is currently not in the database. Examples of how the matching service can find buyers are described below in greater detail. The process 360 then determines in a decision step 382 whether a buyer has been found. If the answer is “yes,” the process 360 in a step 384 matches the seller with the found buyer. The process 360 then ends at the stop 370. If the answer is “no,” the process 360 stores information about the seller in a database for one or more purposes, including for a later attempt to find a buyer. The process 360 then ends at the stop 370.

An example of a phone number matching process that uses the process 360 of FIG. 8B, or some variation thereof, can be as follows. Suppose that Seller3 wants to sell his phone number because he believes that his phone number 779-0000 is a unique and very convenient number. Seller contacts the phone number matching service that includes a Website. Seller3 fills out his contact information including the area code, the number 779-0000 that he wants to sell, and his selling price.

Based on the information provided by Seller3, the phone number matching service automatically sends a confirmation email to Seller3 thanking him and providing him with an order number. The phone number matching service checks its database to see if the number 779-0000 is one of the numbers that are being sought for purchase. For the purpose of this example, suppose that the number 779-0000 is not on such a list.

For a request from a buyer, contacting a potential seller can be as simple as calling the number(s) being sought. However, for a request to sell, a potential buyer is not as readily ascertainable. Thus, the phone number matching service can provide various services to increase the likelihood of a sale of Seller3's number. For example, Seller3's number 779-0000 can be listed on a “Convenient Number” list that can be viewed by potential buyers. Seller3's number can also be linked to a vanity application, so that all or portion of vanity combinations point to the number 779-0000 as a possible option. Seller3's number can simply be put into the database to await any direct match. Seller3's number can be subjected to any combination of these example services. The phone number matching service can charge a recurring fee, depending on the services being provided, until Seller3 cancels or until the number becomes matched and sold.

In one embodiment, the example processes 320 and 360 can store information about the buyer and/or the seller, whether or not a match has been made. Such information can be used in different ways, including by way of examples, market analysis, do-not-contact list (for buyers or sellers who were matched recently and would likely not be interested in buying or selling in the near future), follow-up list (for buyers or sellers who were not matched), and the like.

In one embodiment, information about a given potential buyer and/or seller can be stored in a database until a match is made or until the buyer/seller requests that the information no longer be “listed.” While the information is listed in the database, a listing fee can be charged.

Thus in one embodiment of the process 320 of FIG. 8A, the step 350 (where buyer's information is stored in a database) can include obtaining a consent from the buyer to charge a listing fee for keeping the information in the database. The buyer can then be charged subsequently with the listing fee until a match is found, or until the buyer requests to be removed from the listing.

Similarly in one embodiment of the process 360 of FIG. 8B, the step 390 (where seller's information is stored in a database) can include obtaining a consent from the seller to charge a listing fee for keeping the information in the database. The seller can then be charged subsequently with the listing fee until a match is found, or until the seller requests to be removed from the listing. In one embodiment, the listing fee is for a specified time, and repayment of the fee extends the time.

FIG. 8C shows one embodiment of a process 400 that is usually driven by sellers of phone numbers, or by the matching service itself. In some situations, a seller may simply authorize the matching service to sell and transfer the phone number at a given price. In some situations, the matching service may approach potential sellers to obtain authorizations to sell their phone numbers at desired prices. Preferably, such approaching of the potential sellers by the matching service is performed in a manner that does not violate applicable law(s).

Thus, the process 400 matches a phone number for which the matching service has at least some control or right to transfer. As described above in reference to FIG. 4B, one embodiment of the matching service (224) can include a component (226) that provides such a control to the matching service. Thus, the process 400 can be performed in such a situation.

The process 400 begins at a start 402, and in a step 404, the process 400 obtains at least some control or right to transfer a phone number at a seller's price on behalf of the seller. In a step 406, the process 400 identifies a buyer and matches the buyer with the phone number at a buyer's price that is preferably greater than the seller's price. In one embodiment, the process 400 in a step 408 transfers the phone number to the matched buyer at the buyer's price. The process 400 ends at a stop 410.

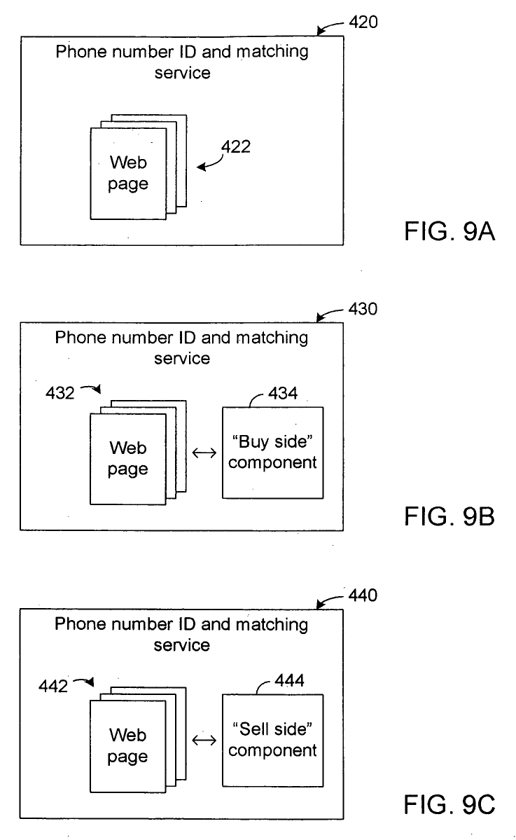

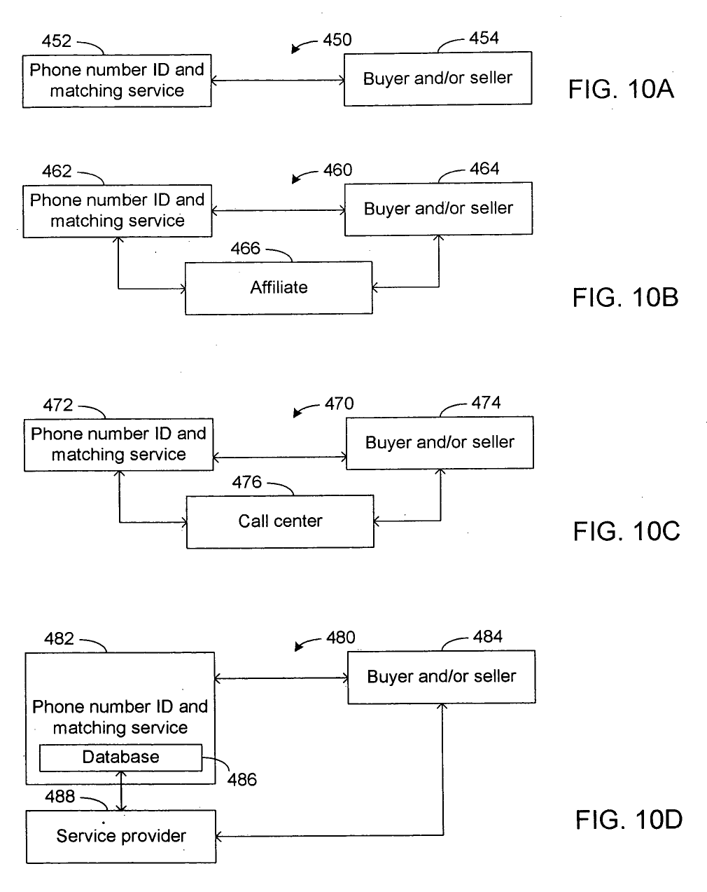

FIGS. 9 and 10 show by examples how the matching service can be configured in various ways to facilitate contacts with potential sellers and buyers. For example, receiving requests to buy phone numbers (step 324 in FIG. 8A), receiving requests to sell phone numbers (step 364 in FIG. 8B), approaching potential sellers (FIG. 8C), or any combination thereof, can be facilitated by one or more example configurations shown in FIGS. 9 and 10.

In one embodiment as shown in FIG. 9A, a matching service 420 may include an internet website 422 that allows seller and/or buyers to interact with the matching service 420. For example, a seller can register with the service 420 by providing seller-identifying information and one or more phone numbers that the seller wishes to sell. The seller may provide a desired selling price for a given phone number. If the seller does not know what the price should be, the website 422 may include information about typical ranges of prices for numbers similar (in area, for example) to the seller's phone number. In another example, a buyer can register with the service 420 by providing buyer-identifying information and one or more phone numbers the buyer wishes to obtain. The buyer may provide a desired buying price for a given phone number. The buying price can also be guided by the example price guideline on the website 422.

In one embodiment as shown in FIG. 9B, a matching service 430 may include a website 432 and a component 434 that promotes a buyer-driven market. The buyer-driven component 434 may include, by way of example, a vanity phone number application, links to and/or from other websites having similar vanity phone number applications, and links to and/or from websites associated with telecommunication companies such as telephone companies and wireless phone companies.

In one embodiment as shown in FIG. 9C, a matching service 440 may include a website 442 and a component 444 that promotes a seller-driven market. The seller-driven component 444 may include, by way of example, a web-based auction application, and links to and/or from other websites having similar “sell side” applications.

One can see that the matching service can be configured in various ways to increase the likelihood of contact with potential sellers and buyers. With web-based interactions, the concept of geographic separation (or lack thereof) between the interacting parties sometimes does not have a meaningful impact. With phone numbers, however, geographic locations and/or area codes can be an important factor. For example, certain area codes and/or certain prefixes within certain area codes can have values (e.g., vanity value) to buyers.

Based on the foregoing, one embodiment of the matching service can be configured to be locality and/or area code specific. It is likely more efficient to perform matching processes for sellers and buyers within a local market such as that defined by an area code. Matching processes can be made more efficient by limiting the matching searches to numbers within the example area code (as opposed to searching all of the area codes). Furthermore, a given area code may have specific local rules that can be incorporated into the matching process, and also into the optional transfer process (once a match is made).

In one embodiment, such as the web-based examples of FIGS. 9A to 9C, sellers and buyers can indicate their locality information by providing information such as area code and/or postal zip code. The matching service can then direct such sellers and/or buyers to appropriate databases associated with the obtained locality information. In one embodiment, such sellers and/or buyers are directed to the appropriate databases after being registered with the matching service. In one embodiment, registration of the sellers and/or buyers may involve a fee or a deposit.

FIGS. 10A to 10D show various example relationships that can be formed by the matching service to improve the manner in which sellers and buyers are contacted and/or serviced. In one embodiment 450 as shown in FIG. 10A, a matching service 452 interacts substantially directly with buyers and/or sellers 454. Such interaction can be web-based, or based on other forms of communication.

In one embodiment 460 as shown in FIG. 10B, a matching service 462 may have a relationship with an affiliate entity 466 that interacts with its base of customers 464. The affiliate 466 may include, for example, a business that sells phones, or a stationery supply business. The example business that sells phones may be a place where customers inquire about the possibility of selling or acquiring phone numbers. The example stationery supply store may be a place where customers print phone numbers on their stationeries; and therefore be open to suggestions that such phone numbers might be sought after, or more desirable phone numbers may be obtainable. A potential phone number seller or buyer obtained by the affiliate 466 can then be referred to the matching service 462 at an agreed-upon fee. In one embodiment, the buyer or seller 464 obtained via the affiliate subsequently can interact substantially directly with the matching service. In another embodiment, the affiliate 466 can process at least some of the matching service based on a database maintained by the matching service.

In one embodiment 470 as shown in FIG. 10C, a matching service 472 may have a relationship with a call center 476. The call center 476 can, for example, make phone calls to potential buyers and/or sellers 474. For example, when a buyer contacts the matching service 472 with a request for a desired phone number, one way for the matching service to find a seller is to simply call the desired phone number. Such calling can be performed by the matching service 472 itself, or as shown in FIG. 10C, can be sub-contracted out to the call center 476. Once the call center 476 makes contact with the potential seller, it (476) can provide information to the matching center 472 about the potential seller. The matching service 472 can then perform its matching process as described herein.

In one embodiment 480 as shown in FIG. 10D, a matching service 482 may include a database 486 that can be accessed in a limited manner by a service provider 488 such as a phone company. The database 486 may contain information about requests received by the service provider 488 regarding potential sellers and/or potential buyers. The matching service 482 can make contacts with such potential sellers and potential buyers based on the information obtained from the database 486.

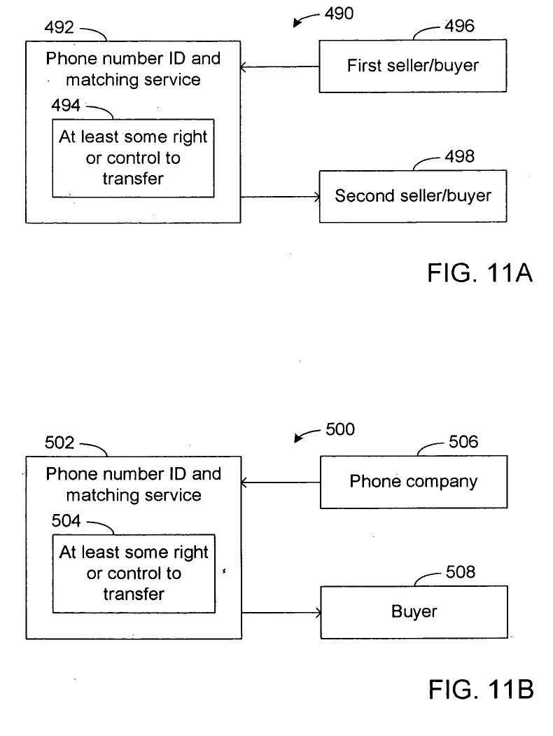

FIGS. 11A and 11B show example embodiments of a phone number matching system where a matching service has at least some right or control to make transactions on phone numbers on behalf of sellers and/or buyers. Such transaction systems have been described above in reference to FIGS. 4B and 8C.

In one embodiment as shown in FIG. 11A, a phone number matching system 490 includes a matching service 492 having at least some right or control (494) to transfer one or more phone numbers associated with a first seller or buyer 496. As described above, an arrangement may be made with the first party 496 as to the phone number to be transferred at a given price. The matching service 492 can then seek out a second party 498 that would match with the first party. The matching service 492 can then transfer the phone number to the second party 498 at a price that is higher than the agreed price with the first party, thereby providing a profit to the matching service 492 for the transaction.

In one embodiment as shown in FIG. 11B, a phone number matching system 500 includes a matching service 502 having at least some right or control (504) to transfer one or more phone numbers held by an entity 506 such as a phone company. As described above, an arrangement may be made with the phone company 506 as to the one or more phone numbers to be sold at given prices. The matching service 502 can then act as an agent of the phone company, and seek out one or more buyers 508 who would be willing to purchase the phone numbers. The matching service 502 can then transfer the phone numbers to the buyers 508 at prices that are higher than the agreed prices with the phone company, thereby providing profit to the matching service 502 for the transactions.

In one embodiment, the right or control component (494 in FIG. 11A and 504 in FIG. 11B) may include a substantially full right to a phone number, where the phone number matching service acquires the phone number from a seller. The phone number matching service can acquire the phone number before or after an end-user or a potential user is identified. The end-user can include a buyer or a lessee (renter) of the phone number.

In one embodiment, the phone number matching service can decide whether to acquire a phone number based on factors such as, but not limited to, the desirability of the phone number, and whether an end-user or a potential end user has been identified. If the desirability of the phone number is relatively high, then the phone number matching service may decide to acquire the number and then find the end-user, while assuming the risk that it may be able to readily find an appropriate end-user such as a renter.

In certain situations, a buyer may not be committed to acquiring a phone number. The buyer may be willing to simply have the right to use the phone number. If a seller having that phone number is identified, the phone number matching service can decide whether to match the seller with the buyer for a sell/buy transaction, or acquire the phone number for the purpose of leasing out the phone number to the non-committed “buyer.”

In one embodiment, the phone number matching service can incorporate such match/acquire decision making as an optional step between the time when a seller is identified and when the buyer/end-user is contacted regarding the availability of the phone number. Even if the buyer has expressed commitment to purchasing that phone number, the phone matching service can provide the option to lease the phone number. Thus, if the buyer wants to purchase the phone number, a match can be made between the seller and the buyer. If the buyer is willing to lease, or if the end-user prefers to lease from the beginning, the phone number matching service may decide to acquire the phone number from the seller and lease it out.

In one embodiment, the phone number matching service can identify and selectively acquire phone numbers that are likely to be desirable. Such numbers may be considered to be desirable enough so that the phone number matching service may be willing to acquire them even before end-users are identified. For example, phone numbers such as “356-9377” (having an alphabet combination “FLOWERS”) can be desirable to merchants such as flower shops. For such a phone number, the phone number matching service can selectively target buyer identification and matching for different area codes.

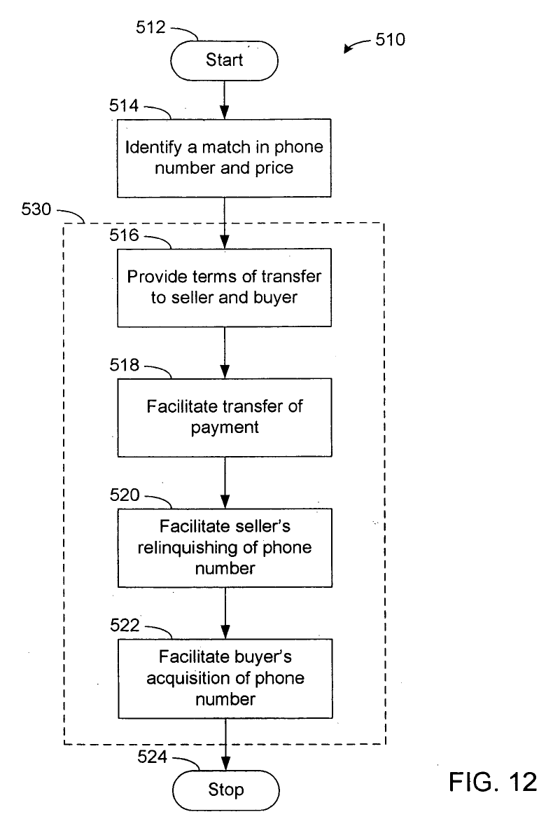

FIGS. 12 to 16 show various example methods of facilitating a transfer of phone number from a seller to a matched buyer after a match has been made. It will be understood that in one embodiment, the matching process and the transfer process can be substantially separate processes. That is, the matching of a seller to a buyer can be achieved without performing the subsequent transfer process. Thus, the transfer process can be analogous to “settlements process” that is performed by the “back office” as used in some business settings.

FIG. 12 shows one embodiment of a process 510 that performs a transfer process 530 after a match is made between a seller and a buyer. The process 510 begins at a start 512, and in a step 514, the process 510 identifies a match between a seller and a buyer for a phone number at a price. For the process 510, the transfer process 530 begins at a step 516, where terms of transfer are provided to the seller and buyer. In a step 518, the process 510 facilitates transfer of payment. In a step 520, the process 510 facilitates seller's relinquishing of the phone number. In a step 522, the process 510 facilitates buyer's acquisition of the phone number. The process 510 ends at a stop 524.

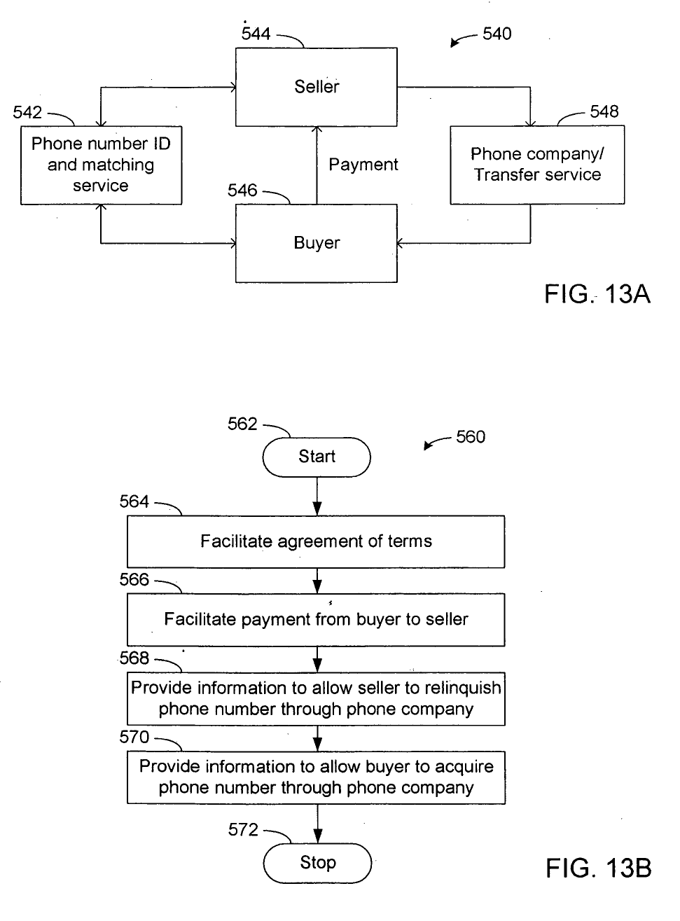

FIG. 13A shows one embodiment of a transfer system 540 that includes a matching service 542 that matches a seller 544 to a buyer 546. Such a matching can be achieved by any of the matching techniques described herein (for example, various embodiments of the matching techniques described above in reference to FIGS. 1-11). To carry out the transfer of the phone number between the matched buyer 546 and the seller 544, a payment is made by the buyer 546 to the seller 544. In exchange for the payment, the seller 544 relinquishes the phone number to the buyer 546. In one embodiment as shown in FIG. 13A, the seller 544 contacts an entity 548 that can carry out an instruction to relinquish the phone number. Such an entity can be a phone company or a transfer service. In one embodiment, the buyer 546 contacts the phone company 548 to obtain the phone number relinquished or to-be-relinquished by the seller 544. Thus as shown in FIG. 13A, the “flow” of phone number “ownership” goes from the seller 544 to the phone company 548, and then to the buyer 546.

FIG. 13B shows a process 560 that can be performed in the example transfer setting of FIG. 13A. The process 560 begins at a start 562, and in a step 564, the process 560 facilitates agreement of terms between the seller and the buyer. In a step 566, the process 560 facilitates payment from the buyer to the seller. In a step 568, the process 560 provides information to the seller to allow the seller to relinquish the phone number through the phone company. In a step 570, the process 560 provides information to the buyer to allow the buyer to acquire the phone number through the phone company. The process ends at a stop 572.

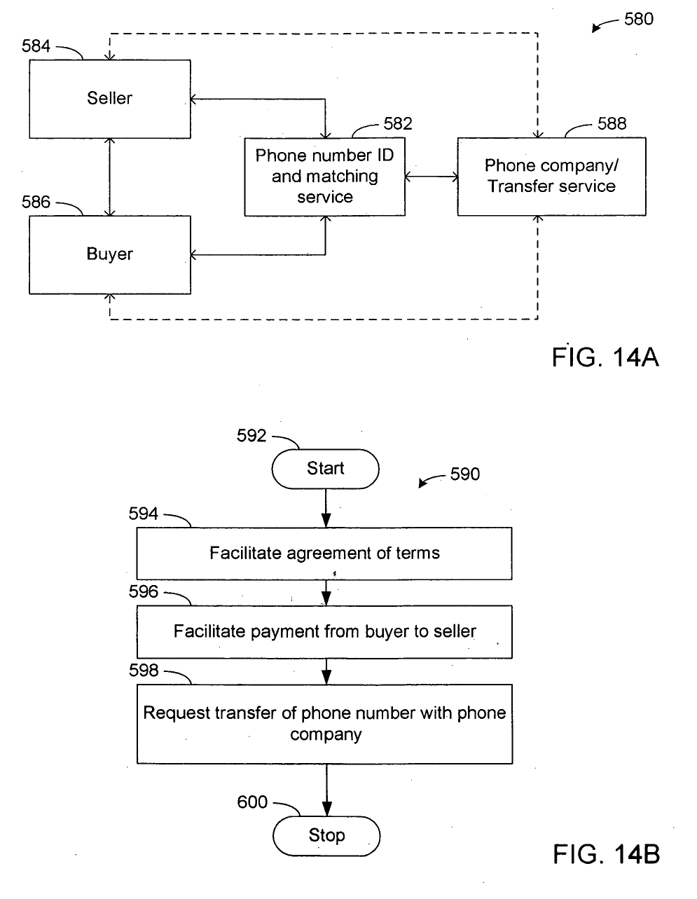

FIG. 14A shows another embodiment of a transfer system 580 that is a variation of the system 540 of FIG. 13A. As with the system 540, a matching service 582 of the system 580 can match a seller 584 with a buyer 586. After the match is made, the matching service 582 can introduce the buyer 586 to the seller 584 so that payment and/or other interaction can be made between them. The matching service 582 interacts with an entity 588 such as a phone company or a transfer service. In such an arrangement, the matching service 582 can “set up” the transfer with the phone company 588, and the transfer can be completed by a verification interaction (depicted as dashed lines) between the phone company 588 and the seller 584, and a verification interaction (depicted as dashed lines) between the phone company 588 and the buyer 586.

FIG. 14B shows a process 590 that can be performed in the example transfer setting of FIG. 14A. The process 590 begins at a start 592, and in a step 594, the process 590 facilitates agreement of terms between the seller and the buyer. In a step 596, the process 590 facilitates payment from the buyer to the seller. In a step 598, the process 590 requests a transfer of the phone number with the phone company. Such a request can include providing information about the seller and the buyer to the phone company, so that the subsequent calls to the phone company (by the seller and the buyer) can be simplified. The process ends at a stop 600.

In the example systems and methods of FIGS. 13 and 14, the payment for the phone number is depicted as being made from the buyer to the seller. In some financial transactions, a buyer may not wish to part with the payment without some protection. One example way of providing such protection to the buyer (and seller also) is to utilize an escrow service.

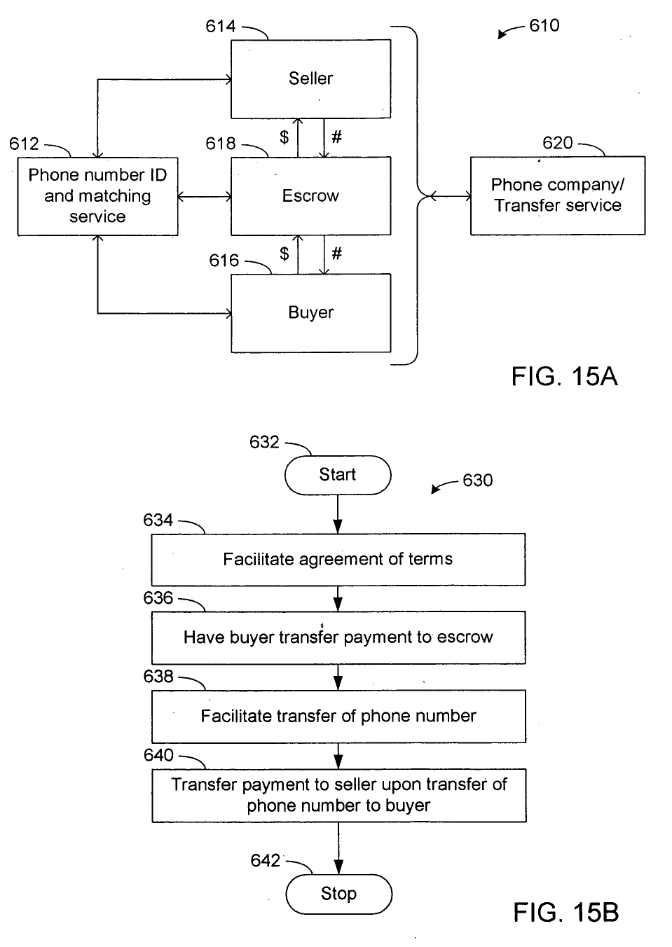

FIG. 15A shows one embodiment of a transfer system 610 having an escrow 618 that provides an escrow service between a seller 614 and a buyer 616. As shown, payment is deposited with the escrow 618 by the buyer 616. For the purpose of description, the phone number is also shown to be relinquished by the seller 614. As with FIGS. 13 and 14, the transfer of the phone number can be facilitated by an entity 620 such as a phone company or a transfer service. Once the phone number is transferred to the buyer 616, the escrow 618 releases the payment to the seller 614.

FIG. 15A further shows a matching service 612 that is assumed to have matched the seller 614 to the buyer 616. The matching service 612 can also interact with the escrow 618 to facilitate the above-described transfer.

In one embodiment, the escrow 618 shown in FIG. 15A can be an entity that is not part of the matching service 612. In one embodiment, the escrow 618 can be an entity that is part of the matching service 612.

FIG. 15B shows a process 630 that can be performed in the example transfer setting of FIG. 15A. The process 630 begins at a start 632, and in a step 634, the process 630 facilitates agreement of terms between the seller and the buyer. In a step 636, the process 630 facilitates transfer of payment from the buyer to the escrow. In a step 638, the process 630 facilitates transfer of the phone number. In a step 640, the process 630 facilitates transfer of payment from the escrow to the seller. The process ends at a stop 642.

In one embodiment, the transfer of the phone number from the seller to the buyer can be achieved as follows. Upon confirmation that payment has been made by the buyer (either directly to the seller, or via some intermediary such as an escrow), the seller can contact the phone company to relinquish the ownership of the phone number. At such a time, the seller can inform that phone company that the buyer will be contacting the phone company to “sign on” as a new owner. In some situations, the buyer may contact the phone company first, and the phone company may process the buyer's sign-on application subject to the seller's relinquishment of the phone number at a later time.

In many transfer transactions with the phone company, the seller and the buyer may need to provide confidential information as a security measure. For example, when a customer signs on with the phone company, confidential information such as social security number, mother's maiden name, and the like can be provided so that the phone company can later verify the authenticity of that customer. Thus, when the seller in the transfer transaction contacts the phone company, it is likely that the phone company will verify the authenticity of the seller based on the confidential information that the seller provided earlier. Furthermore in many transactions, the phone company may use a third-party verification service that independently verifies the identity of the seller.

The foregoing example transfer of the phone number can occur by a direct interaction between the seller and the buyer. That is, the seller can inform the buyer who the phone company is, and coordinate when they should contact the phone company. Alternatively, a third party such as the phone number matching service, an escrow service, or some separate entity, can act as a go-between the seller and the buyer, and coordinate the transfer process. For example, the third party can obtain information about the phone company and provide that information to the buyer.

Applying the foregoing example transfer process to the example transactions described above in reference to FIGS. 8A and 8B (between Buyer1 and Seller1, between Buyer2 and a seller, and between Seller3 and a buyer), the following transfer process can occur. For the Seller1/Buyer1 transaction, the phone number matching service emails both Seller1 and Buyer1 that a match has been made between them, and that they should contact each other to arrange payment (assuming that an escrow service is not being used) and transfer. The email can also include a suggested set of instructions for the payment and transfer. For example, (1) Buyer1 sends payment (for example, by check, money order, cashier's check, or electronic payment); (2) upon receipt of payment, Seller1 calls his phone company to relinquish his ownership of the number 259-3833, and to let the phone company know that the number 259-3833 is to go to Buyer1 (thereby having the phone company “hold” the number for Buyer1); (3) Buyer1 calls the phone company to become the owner of the phone number 259-3833. The instruction to Buyer1 and Seller1 can also include mechanisms for indicating how the transaction occurred (for example, satisfactorily or not), and to provide a customer service contact information (email and/or phone number, for example) that can be used to resolve any problems that may arise.

In one example embodiment, Buyer1 sends the payment to the phone number matching service to facilitate the transfer process. The phone number matching service receiving payments from a buyer can also provide one or more functional features, such as, reducing the likelihood of claims to phone numbers that cannot be vouched for by the phone number matching service, processing of seller fees from the buyer payments, and tracking and controlling payments associated with the matching and/or transfer processes.

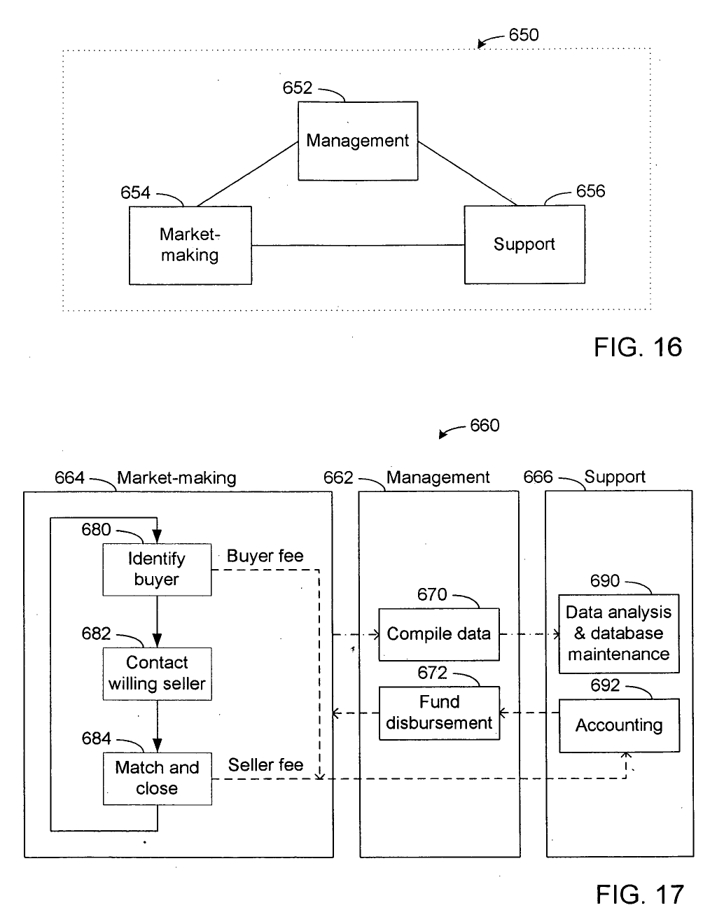

FIG. 16 shows an example of how the matching service business can be structured. In one embodiment, a matching service 650 includes a management component 652, a marketing and operations component 654, and an administration component 656. As shown, the various components of the matching service 650 have at least some interactions with each other.

FIG. 17 shows an example embodiment 660 of the management, marketing and operations, and administration components of FIG. 16. One embodiment of a management component 662 includes a data compilation component 670 and a fund disbursement component 672. One embodiment of a marketing and operations component 664 includes a substantially recurring marketing and operations process that includes steps where buyers are identified (680), willing sellers are contacted (682), and matching and closing are performed (684). One embodiment of a administration component 666 includes a component 690 that analyzes data and maintains the database, and an accounting component 692.

In one embodiment as shown in FIG. 17, for each buyer-seller match made by the marketing and operations component 664, fee can be collected from the buyer, seller, and/or any combination thereof. Such matching fee is forwarded to the accounting component 692 of the administration component 666. The accounting 692 forwards the collected funds to the fund disbursement component of the management 662. The management 662 disburses a compensation (e.g., commission) from the collected fund to the marketing and operations component. The rest of the collected fund, including profit, is retained by the management.

As further shown in FIG. 17, the management 662 via the data compilation component 670 can collect data from the marketing and operations component 664 regarding information such as, but not limited to, trends in desired phone numbers, whom contacted, whom not to contact in the future, customers' willingness to pay the fees, and the like. Such data can be analyzed by the component 670, and can also be forwarded to the data analysis component 690 of the administration component 666 for more detailed analysis.

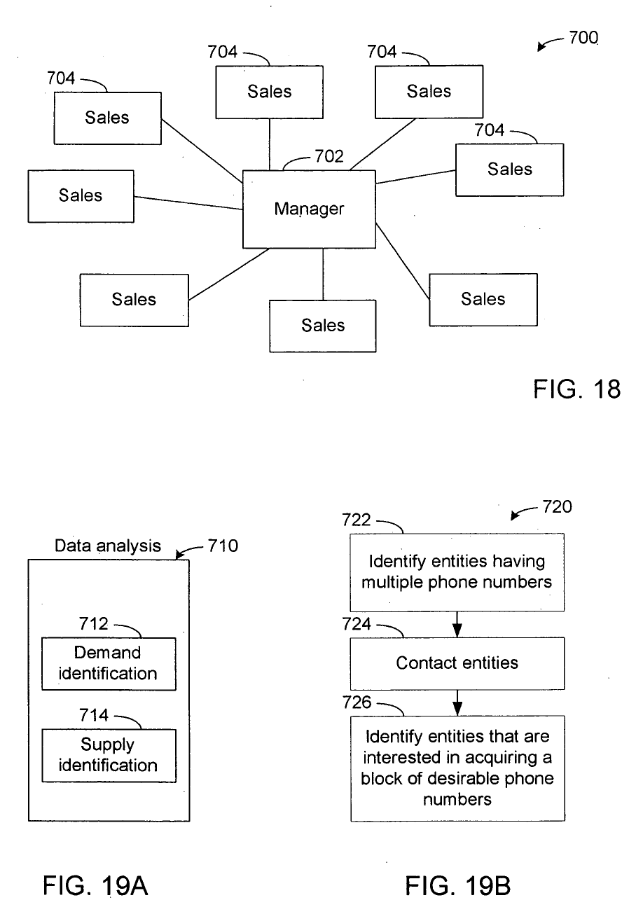

FIG. 18 shows that a manager component 702 can manage a plurality of sales components 704. In one embodiment, the sales component 704 may function similarly to the marketing and operations component 664 described above in reference to FIG. 17. In one embodiment, each sales component 704 includes a sales associate that makes contacts with buyers and/or sellers.

In one embodiment, a phone number matching system can include a plurality of manager components. Each manager 702 can manage a given region—for example a given area code. The plurality of managers and their sales associates can access one or more databases associated with the matching service to facilitate the matching transactions.

FIG. 19A shows an example functionality of a data analysis component 710. In one embodiment, such component can be part of the administration component (666) described above in reference to FIG. 17. As shown in FIG. 19A, the data analysis component 710 can analyze the collected data to identify the demand (712) for certain phone numbers, or certain types of phone numbers. The data analysis component 710 can also analyze the collected data to identify the supply (714) corresponding to the demand. In one embodiment, such information can be used to adjust the fee(s) charged to sellers and/or buyers.

FIG. 19B shows an example process 720 that can be performed as part of the data analysis component 710 of FIG. 19A. Such an analysis can identify a type of market involving blocks of phone numbers that might be desirable to certain entities such as a large institution. The process 720 includes a step 722 where entities that use multiple phone numbers are identified. In a step 724, such entities are contacted to determine whether they would be interested in obtaining a more convenient block of phone numbers. In a step 726, interested entities are identified, and a demand is established.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Consequently, the scope of the invention should not be limited to the foregoing description, but should be defined by the appended claims, where claim language carries an ordinary meaning as in customary usage and not by special definition unless specifically stated as providing a definition.

What is claimed is:

1. A method for providing a phone number matching service, the method comprising:
obtaining a bid from a buyer to buy a first phone number at an at least a first price level;
seeking to obtain an offer from a seller, said offer comprising willingness to sell a second number at a second price level; and
matching said buyer to said seller if:
said first phone number is same as said second phone number; and
said first price level is greater than or equal to said second price level.

2. The method of claim 1, wherein obtaining said bid comprises obtaining a request from said buyer to acquire said first phone number at said first price level.

3. The method of claim 1, wherein obtaining said bid comprises obtaining at least some control or authorization from said buyer to acquire said first phone number on behalf of said buyer.

4. The method of claim 1, wherein obtaining said offer comprises obtaining a request from said seller to sell said second phone number at said second price level.

5. The method of claim 1, wherein obtaining said offer comprises obtaining at least some control or right from said seller to sell said second number on behalf of said seller.

6. The method of claim 1, wherein obtaining said bid or offer comprises providing an internet-based website that allows said buyer or seller to submit said bid or offer electronically.

7. The method of claim 6, wherein the internet-based website includes a web-based auction functionality that facilitates matching of sellers with buyers.

8. The method of claim 1, wherein obtaining said bid or offer comprises providing a relationship with an affiliate entity that facilitates said buyer or seller in submitting said bid or offer.

9. The method of claim 1, further comprising storing said bid and said offer in a database for possible later matching with other sellers or buyers if said matching is not successful.

10. The method of claim 1, further comprising negotiating with said buyer to determine if one of one or more similar alternate phone numbers would be acceptable for buying.

11. The method of claim 1, further comprising facilitating transfer of said first phone number from said seller to said buyer if said matching is successful.

12. The method of claim 1, further comprising determining, prior to matching said buyer to said seller, whether to proceed with said matching or to acquire the second phone number from the seller.

13. A system for matching a buyer with a seller of one or more phone numbers, the system comprising:
a database that comprises:
information about a request from at least one buyer, said request comprising at least a willingness to buy a first phone number; and
information about at least one seller, said information comprising willingness to sell a second number; and
a processor that is configured to match said buyer to said seller if said first phone number is same as or substantially same as said second phone number.

14. The system of claim 13, wherein said request comprises a request from said buyer to acquire said first phone number at a first price.

15. The system of claim 13, wherein said information about the at least one buyer comprises a willingness to provide at least some control or authorization from said buyer to acquire said first number on behalf of said buyer.

16. The system of claim 13, wherein said information about the at least one seller comprises a desire to sell said second phone number at a second price.

17. The system of claim 13, wherein said information about the at least one seller comprises a willingness to provide at least some control or right from said seller to sell said second number on behalf of said seller.

18. The system of claim 13, wherein said database is electronically linked to an internet-based website that allows said buyer or seller to submit said information electronically into said database.

19. The system of claim 18, wherein the internet-based website includes a web-based auction functionality that facilitates matching of sellers with buyers.

20. The system of claim 13, further comprising an affiliate entity that interacts with said buyer or seller so as to facilitate said buyer or seller in submitting said information into said database.

21. The system of claim 13, further comprising a transfer module that facilitates transfer of said first phone number from said seller to said buyer.

22. The system of claim 13, wherein the processor is further configured to determine, prior to matching said buyer to said seller, whether to proceed with said matching or to acquire the second number from the seller.

23. A method for utilizing a database, the method comprising:
obtaining information about one or more buyers, each of said one or more buyers being interested in buying a phone number;
storing said information about one or more buyers in said database;
retrieving information about a first buyer from the stored information about said one or more buyers, said first buyer being interested in buying a first phone number; and
contacting a potential seller having said first phone number to determine whether said potential seller is willing to sell said first phone number to said first buyer.

24. The method of claim 23, further comprising matching said first buyer to said potential seller if said potential seller is willing to sell the first phone number.

25. The method of claim 24, wherein matching further comprises determining whether a bid price of said first buyer is greater than or equal to an offer price of said potential seller.

26. The method of claim 25, wherein matching further comprises designating said potential seller as a seller if said bid price is greater or equal to said offer price.

27. The method of claim 26, further comprising facilitating transfer of said first phone number from said seller to said first buyer.

28. The method of claim 23, wherein obtaining information about said one or more buyers comprises providing an internet-based website that allows electronic interactions with at least some of said one or more buyers.

29. The method of claim 28, wherein the internet-based website includes a web-based auction functionality that facilitates matching of sellers with buyers.

30. The method of claim 23, wherein obtaining information about said one or more buyers comprises providing a relationship with an affiliate entity that facilitates interactions with at least some of said one or more buyers.

31. A system, comprising:
a database that is configured to include information about a plurality of buyers, each of said plurality of buyers being interested in buying a phone number;
an interface that is configured to allow retrieval of information about a first buyer from said database, said first buyer being interested in buying a first phone number; and
a communication component that facilitates contact with a potential seller having said first phone number to determine whether said potential seller is willing to sell said first phone number.

32. The system of claim 31, further comprising a matching component that is configured to match said first buyer to said potential seller if said potential seller is willing to sell the first phone number.

33. The system of claim 32, wherein said matching component is further configured to determine whether a bid price of said first buyer is greater than or equal to an offer price of said potential seller.

34. The system of claim 33, wherein said matching component is further configured to designate said potential seller as a seller if said bid price is greater or equal to said offer price.

35. The system of claim 34, further comprising a transfer component that facilitates transfer of said first phone number from said seller to said first buyer if said matching is successful.

36. The system of claim 31, further comprising an internet-based website that is electronically linked to said database, said website being accessible to at least some of said plurality of buyers thereby allowing at least some of said plurality of buyers to submit information via said website.

37. The system of claim 36, wherein the internet-based website includes a web-based auction functionality that facilitates matching of sellers with buyers.

38. The system of claim 31, further comprising an affiliate entity that interacts with at least some of said plurality of buyers so as to facilitate obtaining of information about at least some of said plurality of buyers.

39. A method for providing phone number matching service, the method comprising:
receiving a request from a buyer desiring to purchase a phone number;
determining from the buyer a purchase price range;
identifying the owner of the phone number;
determining whether the owner is willing to sell the phone number; and
facilitating transfer of the phone number if the owner is willing to sell the phone number.

40. The method of claim 39, wherein determining the purchase price range comprises determining a bid price.

41. The method of claim 39, wherein determining the purchase price range comprises determining a bid and a maximum price that the buyer is willing to pay for the phone number.

42. The method of claim 39, wherein identifying the owner of the phone number comprises calling the phone number.

43. The method of claim 39, wherein facilitating transfer of the phone number comprises referring the buyer and the owner to a third party entity that facilitates payment of the purchase price and transfer of the ownership of the phone number.

44. The method of claim 39, wherein facilitating transfer of the phone number comprises providing an escrow service that facilitates payment of the purchase price and transfer of the ownership of the phone number.

45. The method of claim 39, wherein facilitating transfer of the phone number comprises providing instructions to the buyer and the owner on payment of the purchase price and transfer of the ownership of the phone number.

46. The method of claim 39, further comprising storing information about the buyer if the owner of the phone number is not willing to sell the phone number.

47. The method of claim 46, wherein the stored information is used for possible matches at a later time.

48. A method for providing a phone number matching service, the method comprising:
obtaining a request from a buyer to buy a first phone number;
seeking to obtain an offer from a seller, said offer comprising willingness to sell a second number; and
facilitating a transfer of said first phone number to said buyer from said seller.

49. The method of claim 48, wherein obtaining said request comprises obtaining a request from said buyer to acquire said first phone number at a first price level.

50. The method of claim 48, wherein obtaining said offer comprises obtaining a request from said seller to sell said second phone number at a second price level.

51. The method of claim 48, wherein obtaining said offer comprises obtaining at least some control or right from said seller to sell said second number on behalf of said seller.

52. The method of claim 48, wherein obtaining said request or offer comprises providing an internet-based website that allows said buyer or seller to submit said bid or offer electronically.

53. The method of claim 52, wherein the internet-based website includes a web-based auction functionality that facilitates matching of sellers with buyers.

54. The method of claim 48, wherein obtaining said request or offer comprises providing a relationship with an affiliate entity that facilitates said buyer or seller in submitting said bid or offer.

55. The method of claim 48, further comprising storing said request and said offer in a database for possible later matching with other sellers or buyers if said matching is not successful.

56. The method of claim 48, further comprising negotiating with said buyer to determine if one of one or more similar alternate phone numbers would be acceptable for buying.
